(19) United States
(12) Patent Application Publication
(10) Pub. No.: US 2025/0189631 A1
(43) Pub. Date: Jun. 12, 2025

(54) RADAR-BASED MOTION-ACTIVATED LIGHTING AND TRACKING

(71) Applicant: Google LLC, Mountain View, CA (US)

(72) Inventor: Aditya S. Ghadiali, San Jose, CA (US)

(73) Assignee: Google LLC, Mountain View, CA (US)

(21) Appl. No.: 18/532,676

(22) Filed: Dec. 7, 2023

(51) Int. Cl. G01S 7/41; G01S 7/02; G01S 13/66; G01S 13/86

(52) U.S. Cl. CPC G01S 7/415; G01S 7/027; G01S 13/66; G01S 13/867

(57) ABSTRACT

Various arrangements of radar-based lighting and tracking systems are presented herein. Radar signals may be output into an environment. Based on reflected radar signals, a target may be identified. Various characteristics of the target can be analyzed. In response to characteristics, lighting may be activated and aimed at the target. A camera may be used to capture and record images of the illuminated target.

### BACKGROUND

Floodlights and spotlights are typically used in conjunction with cameras for home security to improve visibility and to provide active illumination more powerful than the camera's infrared-based night vision, to capture an image with better contrast. A low power, low cost motion sensor, such as a passive infrared (PIR) sensor combined with a Fresnel lens, can be used to activate the light and/or camera.

However, PIR sensors can have significant drawbacks. PIR sensors are susceptible to false positives from a number of different sources. A PIR sensor functions as a single pixel sensor, thereby providing no information other than whether or not motion was detected. In addition, since a PIR sensor functions as a differential sensor, it cannot detect static presence. Further, PIR sensors tend to have lower sensitivity when compared to other technologies, for example a person wearing thermally insulating clothing may not be detected, resulting in a security risk.

### SUMMARY

Various arrangements of a radar-based lighting and tracking system and methods of use are provided herein. Such a system can include a radar system, that includes a plurality of antennas, a radar sensor, and a processing system. The processing system can use reflected radar signals received via the plurality of antennas, to determine a location of a target. The processing system then can output an indication of the target, such as to a server or a lighting system. The system can further include a lighting system that includes a plurality of lights that can be individually illuminated. A subset of the plurality of lights can be illuminated based on the indication output by the radar system.

Embodiments of such a system can include one or more of the following features: A camera system may be included. The camera system can be configured to determine a direction which the target is facing. The subset of the plurality of lights being illuminated can be based at least in part on the direction which the target is facing as determined by the camera system. The radar system can have multiple receive antennas. TShe radar system and the lighting system can be housed by a common housing. As the target moves, the target can be tracked by light output by the lighting system based on indications of the target output by the radar system.

### BRIEF DESCRIPTION OF THE DRAWINGS

A further understanding of the nature and advantages of various embodiments may be realized by reference to the following figures. In the appended figures, similar components or features may have the same reference label.

FIG. 1 illustrates an embodiment of a block diagram of a radar-based lighting and tracking system.

FIG. 2 illustrates an embodiment of a method for performing radar-based lighting and/or video recording.

### DETAILED DESCRIPTION

Rather than using a PIR sensor, a radar sensor may be used. A radar sensor system can have one or more antennas, a microcontroller, an oscillator, and voltage regulators for power supply noise rejection built in. A radar sensor can be used in combination with a light (e.g., floodlight, spotlight) to: 1) determine when a target (e.g., person, animal) is present; and 2) to track the target. Such an arrangement can allow for improved control over a lighting system, such as by targeting light at the location where the target was detected and following the target with light as it moves.

Additionally or alternatively, a radar sensor system can be used in combination with a camera system. The radar sensor system can be used to detect the presence of a person and, possibly, cause a light to be activated. The camera can be used to discern additional information about the person, such as the direction the person is facing and/or an identity of the person. For example, known persons may not trigger a security alert or persons (whether known or unknown) that are facing away from the camera may not trigger a security alert.

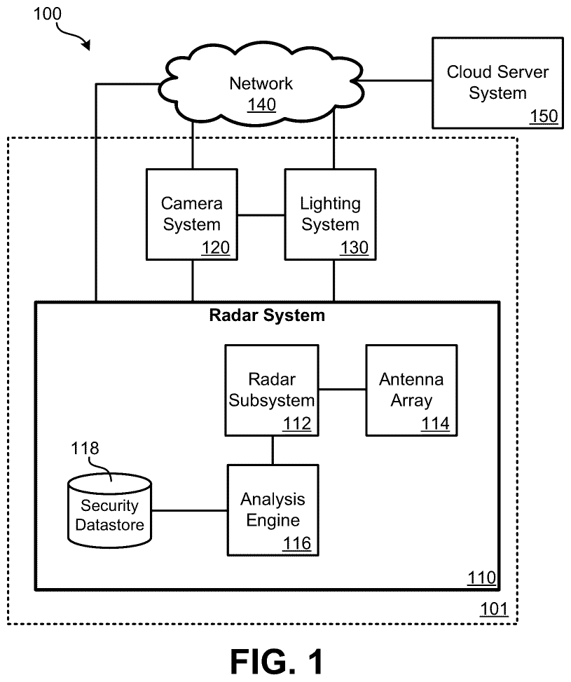

Additional details are provided in relation to the figures. FIG. 1 illustrates an embodiment of a block diagram of a radar-based lighting and tracking system 100 (“system 100”). System 100 can include: radar system 110; camera system 120; lighting system 130; network 140; and cloud server system 150. Radar system 100 can include various components, including: radar subsystem 112; antenna array 114; analysis engine 116; and security datastore 118.

In some embodiments, radar system 110, camera system 120, and lighting system 130 are separate devices. In other embodiments, radar system 110 and lighting system 130 are incorporated as a single device in housing 101. In other embodiments, radar system 110 and camera system 120 are incorporated as a single device in housing 101. In still other embodiments, radar system 110, camera system 120, and lighting system 130 are all incorporated as a single device within housing 101.

Antenna array 114 may include multiple antennas or may be just a single antenna. The antennas may be physically tilted in one direction or the other, or multiple transmit antennas may be used to steer the beam in azimuth and/or elevation. In some embodiments, radar system 110 can include a sensor, such as an inertial measurement unit (IMU) to determine an orientation in which radar system 110 has been installed relative to the ground. Such an IMU may be a magnetometer or accelerometer. In some embodiments, separate antennas are present for transmission and reception. A one-transmit and one-receive antenna solution can have multiple antennas (e.g., end-fire array or patch antennas) connected with an RF switch that functions as part of radar system 110 to allow radar system 110 to pick between at least two possible antenna configurations (e.g., pointing up or down), thus allowing the radar system 110 to be vertically flipped without negatively affecting performance.

In one arrangement, a single transmit antenna may be used in conjunction with one or two receive antennas present in antenna array 114. Such an arrangement may be lower cost than a PIR sensor implementation. Alternatively, additional transmit and/or receive antennas, as detailed below, can allow for enhanced functionality.

Antenna array 114 is connected with or otherwise in communication with radar subsystem 112. Radar subsystem 112 may be implemented using one or more processors to perform processing of radar signals to be emitted and/or of received reflected radar signals. Radar subsystem 112 can be in communication with analysis engine 116, which can be implemented with the same or different processors and can perform clutter removal or background subtraction in the time domain by subtracting a slow-moving, windowed average over a long history from the current measurement of the radar to remove long-static objects. If a moving object is detected in the field of view, a stack of “static” frames averaged over for clutter removal is not updated. Once clutter has been removed, a two dimensional fast Fourier transform (2D FFT) is performed for each frame over the matrix of samples per chirp×chirps per frame. To improve efficiency, the 2D FFT may be run in two steps—first over the samples per chirp to determine which range bin has the highest magnitude, and then over the chirps per frame for that specific range bin (or k-nearest neighbors) to get velocity of motion. The sign of the velocity can indicate the direction (e.g., moving towards or away from the device).

Security Datastore 118 can store user preferences such as defining a zone in which monitoring should be performed (to the exclusion of some other area) and on how radar system 110 should react when a target is detected within the zone. If the detection takes place within a user's desired zone and, possibly, the magnitude of the radar cross section is within the expected sensitivity specified by the user, an action can be taken. For example, radar system 110 could enable lighting system 130, enable camera system 120, or both. In some embodiments, radar system 110 is incorporated as a same device that includes camera system 120, lighting system 130, or both. In other embodiments, radar system 110 may be separate and either communicate directly (e.g., via a wire or wireless communication technology) or may relay communications through network 140. In some embodiments, radar system 110 communicates with cloud server system 150, which sends commands to camera system 120 and/or lighting system 130. Regardless of embodiment, when a target is detected, radar system 110 can trigger lighting system 130 to illuminate and/or camera system 120 to record (or, if already recording) to bookmark a security concern.

In some embodiments, a CFAR algorithm, such as OS-CFAR, cell-averaging CFAR, can be leveraged to manage the detection threshold of a target. A classifier (e.g., Naive Bayes, Support Vector Machines or logistic regression) can be executed to determine whether a target is a person or vehicle, then pass that information to camera system 120, cloud server system 150 and/or lighting system 130 to facilitate tracking of the target between systems. (If separate devices are used, a set up process may be performed to determine the relative positions and field of view of the devices with respect to each other.)

In some embodiments, antenna array 114 can include two transmit and two receive antennas or one transmit and three receive antennas. Such an arrangement can allow for an angle of arrival (AoA) to be determined or estimated and a location of a target to be determined in space. Over time, this information can be used to determine the target's velocity and determine if the target is moving toward, away, or crossing in front of antenna array 114. For example, a person lurking or coming towards radar system 110 may be considered a security risk, while a person crossing in front of the radar system 110 may not be considered a security risk (e.g., a person walking along a sidewalk). Camera system 120 can augment this capability by determining a direction in which a target is facing and providing a second source of data using single-shot detectors for person detection and kernelized correlation filters for tracking. In some embodiments, a target facing camera system 120 (e.g., for at least a threshold period of time) may be determined to be a security risk.

If two transmit antennas are present in antenna array 114, each receive antenna can additionally function as a second “virtual” receive antenna to determine an AoA based on the spacing between the transmit antennas, which results in a phase difference at the receive antenna depending on from which transmit antenna the radar was emitted. An increase in the number of transmit antennas, receive antennas, or both can be used to improve the angular resolution and have a higher confidence in tracking. In addition, higher angular resolution can be used to determine the radar cross section of the target, which is useful in classifying the difference between vehicles, humans, and animals.

Tracking information, including location, depth, velocity, and/or motion history can allow for tracking to be done with less computation than with an image-based sensor that uses computer vision or machine learning. If images of the target are to be captured, coordinates can be passed to camera system 120 indicating a portion of a field of view to be captured and recorded by camera system 120.

Lighting system 130 can include multiple, individually illuminable lights. Depending on the location of a target determined by radar system 110, only one or more lights that are targeted at the location of the target may be illuminated. Thus, as a target moves, which lights of lighting system 130 are illuminated can change to keep the target lit. If lighting system 130 includes multiple LEDs, the duty cycle of the power provided to each LED may be adjusted to follow the target. If multiple targets are detected, all lights may be illuminated to flood the area with light as opposed to tracking individual targets. In some embodiments, lighting system 130 can include a light that is physically aimed using one or more motors. Such motors may be actuated to keep the light pointed at the target.

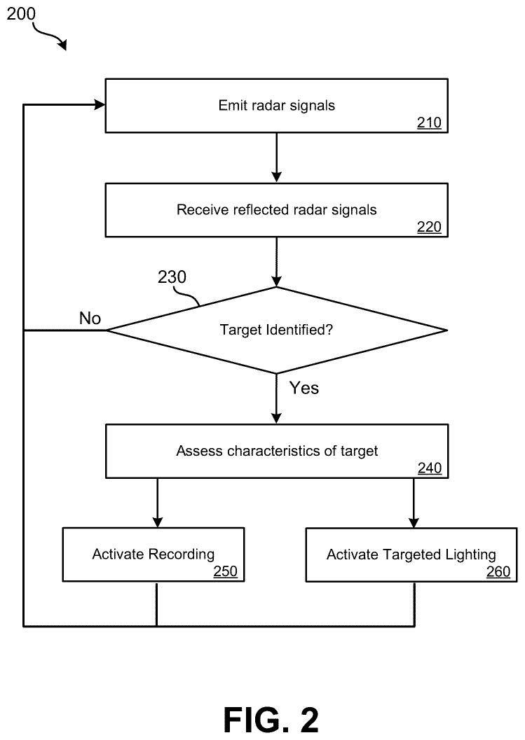

Various methods may be performed using an embodiment of system 100. FIG. 2 illustrates an embodiment of a method 200 for performing radar-based lighting and/or video recording. Method 200 can be performed using system 100.

At block 210, radar signals can be emitted by an antenna array from one or more transmit antennas. If multiple transmit antennas are present, from which antenna radar signals are emitted can vary. The emitted radar signals may be frequency-modulated continuous-wave (FMCW) radar signals.

At block 220, emitted radar signals that are reflected back to the antenna array are received using one or more receive antennas. As part of block 220, various processing of the radar signals may be performed, such as to remove data due to long-time static objects that reflect radar (e.g., stationary objects, walls, etc.).

At block 230, a target may be identified. A target may be an object that reflects a threshold amount of emitted radar signals. If no target is identified, method 200 may return to block 210 and continue emitting radar signals and monitoring for a target. If a target is identified, method 200 proceeds to block 240.

At block 240, characteristics of the target can be assessed, such as by the radar system or by cloud server system 150. Characteristics that can be assessed are: 1) distance to the target from the radar system; 2) direction of movement of the target; 3) velocity of movement of the target; 4) angle of arrival (if the radar system has multiple transmit or multiple receive antennas); 5) estimated radar cross-section (if the antenna array has a sufficient number of transmit and receive antennas); 6) amount of time loitering; and 7) whether the target is likely a person. In some embodiments, to assist in detecting characteristics, camera system 120 may be activated and/or location information of the target may be provided to the camera system. The camera system may be used to determine: 1) which direction the target is facing; 2) whether the target is a known user (e.g., who has a stored user profile, such as in security datastore 118). This information can be communicated to radar system 110 or may be communicated to cloud server system 150 for analysis.

At block 250, based on block 240, video recording or image capture may be activated. In some embodiments, only a portion of the camera's field of view is captured or highlighted based on location information of the target detected by the radar system. Additionally or alternatively to block 250, at block 260, again based on block 240, lighting is enabled based on the characteristics. Location information may be provided to a lighting system to only illuminate particular lights or to aim illumination in a particular direction to where the target is located. As the target moves, the location provided to the lighting system can be updated to keep the target illuminated.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A radar-based lighting and tracking system, comprising:
a radar system, comprising:
a plurality of antennas;
a radar sensor; and
a processing system, comprising one or more processors, configured to:
using reflected radar signals received via the plurality of antennas, determine a location of a target; and
output an indication of the target; and
a lighting system, comprising:
a plurality of lights that can be individually illuminated, wherein a subset of the plurality of lights are illuminated based on the indication output by the radar system.

2. The radar-based lighting and tracking system of claim 1, further comprising a camera system, wherein the camera system is configured to determine a direction which the target is facing.

3. The radar-based lighting and tracking system of claim 2, wherein the subset of the plurality of lights being illuminated is based at least in part on the direction which the target is facing as determined by the camera system.

4. The radar-based lighting and tracking system of claim 1, wherein the radar system comprising multiple receive antennas.

5. The radar-based lighting and tracking system of claim 1, wherein the radar system and the lighting system are housed by a common housing.

6. The radar-based lighting and tracking system of claim 1, wherein as the target moves, the target is tracked by light output by the lighting system based on indications of the target output by the radar system.
